(19) United States
(12) Patent Application Publication
(10) Pub. No.: US 2026/0205166 A1
(43) Pub. Date: Jul. 16, 2026

(54) RIS IMPACT ON RACH PROCEDURE

(71) Applicant: Huawei Technologies Co., Ltd., Shenzhen (CN)

(72) Inventors: Ahmad Mustafa Musa Abu Al Haija, Ottawa (CA); Mohammadhadi Baligh, Ottawa (CA)

(21) Appl. No.: 19/562,507

(22) Filed: Mar. 10, 2026

Related U.S. Application Data
(63) Continuation of application No. PCT/CN2023/117965, filed on Sep. 11, 2023.

(51) Int. Cl. H04B 7/04; H04W 74/0833

(52) U.S. Cl. CPC H04B 7/04013; H04W 74/0833

(57) ABSTRACT

Updates to the existing Random Access Channel (RACH) procedure and updates to messages used in the RACH procedure may be shown to allow a base station, or another network element, determine whether communication with a user equipment (UE) are to be carried out with or without help from one or more Reconfigurable Intelligent Surfaces (RIS).

### CROSS REFERENCE

The present application is a continuation of International Application No. PCT/CN2023/117965, filed on Sep. 11, 2023, the disclosure of which is hereby incorporated by reference in its entirety.

### TECHNICAL FIELD

The present disclosure relates, generally, to wireless mobile communication and, in particular embodiments, to configuring Reconfigurable Intelligent Surfaces to reduce ambiguity in a location for a mobile communication device that is engaged in a Random Access Channel (RACH) procedure.

### BACKGROUND

It is known that a Random Access Channel (RACH) procedure plays a significant role in the establishment of an initial connection between a device and a network element. When a device is to connect to a network for the first time, or after a period of inactivity, the device uses the RACH procedure to request access to the network. A RACH procedure may also be used for other purposes. For one example, a RACH procedure may be used in a handover process. For another example, a RACH procedure may be used when re-establishing synchronization. For a further example, a RACH procedure may be used as part of a beam failure recovery process. The term “Initial Access (IA)” process is given to a sequence of steps carried out by user equipment (UE) and a network element (often referenced as a “gNB”), where the goal is for the UE to acquire uplink synchronization and obtain an identifier that the UE may use for future communication with the gNB.

The IA process may be understood to begin with the gNB transmitting synchronization signal block (SSB) bursts in a plurality of directions. Upon detecting receipt of an SSB in a burst, a UE may commence a conventional, four-step RACH procedure. The four-step RACH procedure is defined by a sequence of messages, which are generally referred to as MSG1, MSG2, MSG3 and MSG4.

MSG1 is a random access request with a preamble. The UE selects a random access preamble from a set of predefined preambles. In a situation wherein the UE receives a plurality of SSBs in a burst, the UE may select one SSB among the plurality of SSBs. After selecting the preamble, the UE transmits the preamble on the Physical Random Access Channel (PRACH). In a situation wherein the UE has selected one SSB among the plurality of SSBs, the selected preamble may correspond to the selected SSB.

MSG2 is a random access response. Upon receiving MSG1, the gNB (also known as a “base station” or “BS”) sends MSG2 as a response. MSG2 is known to include several pieces of information, such as a Time Advance (TA) command for timing adjustment, a Random Access Preamble Identifier (RAPID) matching the preamble transmitted, by the UE in MSG1, and an initial uplink grant for the UE. The gNB also known to assign a temporary identifier called a Random Access Radio Network Temporary Identifier (RA-RNTI) to the UE.

Using the initial uplink grant that was provided in MSG2, the UE transmits MSG3 on a Physical Uplink Shared Channel (PUSCH). MSG3 may carry a radio resource control (RRC) message. Alternatively, MSG3 may carry pure PHY data.

MSG4 may be understood to include a contention resolution message. MSG4 may also include RRC connection setup information. After receiving and processing MSG3, the gNB sends MSG4 to the UE. MSG4 may carry media access control (MAC) data for contention resolution. The contention resolution message may contain an indication of an identity of the UE, thereby confirming that the gNB has correctly identified the UE and thereby confirming that any contention has been resolved. At this step, the gNB may provide the UE with a Cell Radio Network Temporary Identifier (C-RNTI).

A two-step RACH procedure has also been defined. The two-step RACH procedure is defined by a sequence of messages, which are generally referred to as MsgA and MsgB. In a first step of the two-step RACH procedure, the UE transmits MsgA. The first step of the two-step RACH procedure may be recognized as a combination of step 1 and step 3 of the four-step RACH procedure. In a second step of the two-step RACH procedure, the UE transmits MsgB. The second step of the two-step RACH procedure may be recognized as a combination of step 2 and step 4 of the four-step RACH procedure.

Reconfigurable Intelligent Surfaces (RIS) have received heightened research interest as a valuable technology for future wireless networks. A RIS has an array of elements that may be configured to manipulate an incident wave/signal while reflecting the incident wave/signal. That is, the manipulation may be shown to cause the reflected wave to have a phase that is distinct from the phase of the incident wave. In other configurations, the manipulation may be shown to cause the reflected wave to have an amplitude, a polarization or a frequency that is distinct from the respective amplitude, polarization or frequency of the incident wave. In addition to, or instead of, manipulating the incident wave, the RIS may reflect all or some of the incident wave in a specific direction. For detailed information on RIS configuration, see E. Basar et al., “Wireless Communications Through Reconfigurable Intelligent Surfaces,” available as arxiv.org/pdf/1906.09490.pdf, July 2018 and B. Xiong et al., “Controlling the degrees of freedom in metasurface designs for multi-functional optical devices,” Nanoscale Advances, September 2019.

The manipulation may be achieved by configuring the RIS elements via bias voltages that are controlled by a control circuit connected to the RIS. The manipulation may be achieved by configuring the RIS elements via other methods, including methods that involve mechanical deformation and methods that involve use of phase change materials. It follows that, for beamforming, RIS elements may be configured to provide desired phase-shifts for an incident-wave to be redirected in a desired direction, say, toward a particular destination device.

With such beamforming capability, a RIS may be utilized during an IA process to, thereby, assist a UE in a task related to establishing a radio resource control (RRC) connection with, say, a base station. While the involvement of a RIS may be shown to have a cost associated with, for example, an increase in a size of each SSB in a burst, it may be shown that the involvement of a RIS may be associated with a benefit associated with an extension of coverage for a base station, or an access point, especially for high frequency bands, like the known mmWave bands and the known sub-THz bands.

The benefits of the involvement of a RIS may be balanced with a cost, in that there may be ambiguity in the location of mobile communication devices. That is, a given UE may not be able to determine whether one or more RIS are involved in detection, by the UE, of an SSB in a burst. It follows that network elements, such as base stations, may not be able to determine whether one or more RIS are involved in reception, at the base station, of a random access request (MSG1) from a UE.

### SUMMARY

Aspects of the present application relate to updates to the existing RACH procedure and updates to messages used in the RACH procedure so that a base station, or another network element, may determine whether communication with a user equipment may be carried out with or without help from one or more RIS. Similarly, a RACH procedure that is updated according to aspects of the present application may allow the base station to inform a UE that communication with the base station is being carried out with or without help from one or more RIS.

In some known approaches, it is proposed to update an SSB transmission to assist a UE in a task of detecting existence of a RIS during the SSB transmission portion of the IA process. The SSB payload is updated to include a set of SSBs that pertain different RISs and a signature from each RIS. Then, upon detecting an SSB, the UE may know whether the detected SSB has been received with or without RIS help. However, such updates increase the SSB payload by adding the set of SSBs for different RISs in a given network. Such updates may also be shown to require increased processing at the UE.

It may be shown that those aspects of the present application that allow for determining whether a UE received a signal directly, from a BS, or via one or more RIS, have little, or no, impact on SSBs and cell search procedures. It may also be shown that, through the implementation of aspects of the present application, one result may be improved RIS utilization, in that unnecessary configurations are avoided. It may further be shown that aspects of the present application may be extended to beam tracking and refinement after an RRC connection has been established.

According to an aspect of the present disclosure, there is provided a method. The method includes transmitting, to a Reconfigurable Intelligent Surface (RIS), instructions specifying a first mode for a first resource and a second mode for a second resource. The method further includes transmitting, to a device, a first outbound message, the first outbound message including an initial uplink grant allocating the first resource, receiving, in the first resource from the device, a first inbound message, receiving, in the second resource from the device, a second inbound message and determining, based on the receiving the second inbound message in the second resource, that communication with the device occurs via the RIS. Further aspects of the present disclosure related to an apparatus including a processor caused to carry out this method and a computer-readable medium for causing a processor to carry out this method.

According to an aspect of the present disclosure, there is provided a method. The method includes receiving, from a network element, a first inbound message, the first inbound message including an initial uplink grant allocating a first resource and, responsive to receiving the first inbound message, transmitting, in the first resource, a first outbound message and transmitting, in a second resource, a second outbound message. Further aspects of the present disclosure related to an apparatus including a processor caused to carry out this method and a computer-readable medium for causing a processor to carry out this method.

According to an aspect of the present disclosure, there is provided a method. The method includes transmitting, to a Reconfigurable Intelligent Surface (RIS), instructions specifying a first mode for implementing in a first resource and a second mode for implementing in a second resource. The method further includes transmitting, to a device, outbound messages, the outbound messages including in the first resource, a first outbound message and, in the second resource, a second outbound message. The method further includes receiving an inbound message, the inbound message including an indication indicating that one or more of the outbound messages has been received at the device and determining, based on having received one or more of the outbound messages, whether communication with the device occurs via the RIS. Further aspects of the present disclosure related to an apparatus including a processor caused to carry out this method and a computer-readable medium for causing a processor to carry out this method.

According to an aspect of the present disclosure, there is provided a method. The method includes receiving, from a network element, one or more inbound messages and transmitting, to the network element, an outbound message, the outbound message including an indication about the one or more inbound messages that have been received. Further aspects of the present disclosure related to an apparatus including a processor caused to carry out this method and a computer-readable medium for causing a processor to carry out this method.

According to an aspect of the present disclosure, there is provided a method. The method includes transmitting, to a device, a first outbound message, the first outbound message including a request for information related to receiving a synchronization signal block (SSB) received at the device, receiving, from the device, an inbound message, the inbound message including the information related to the SSB and, responsive to the receiving the inbound message, determining, based on the information related to the SSB, whether the communication with the device is via one or more Reconfigurable Intelligent Surface. Further aspects of the present disclosure related to an apparatus including a processor caused to carry out this method and a computer-readable medium for causing a processor to carry out this method.

According to an aspect of the present disclosure, there is provided a method. The method includes receiving a synchronization signal block (SSB), receiving, from a network entity, a first inbound message, the first inbound message including a request for information related to receiving the SSB and transmitting an outbound message, the outbound message including the information related to the SSB. Further aspects of the present disclosure related to an apparatus including a processor caused to carry out this method and a computer-readable medium for causing a processor to carry out this method.

According to an aspect of the present disclosure, there is provided a method. The method includes transmitting, to a Reconfigurable Intelligent Surface (RIS), instructions specifying incident signal manipulation, transmitting a first outbound message, receiving an inbound message and determining, based on whether signal manipulation has been detected in the inbound message, whether the RIS was involved in the receiving of the inbound message. Further aspects of the present disclosure related to an apparatus including a processor caused to carry out this method and a computer-readable medium for causing a processor to carry out this method.

According to an aspect of the present disclosure, there is provided a method. The method includes receiving, from a device, a first message, transmitting, to the device, a second message, the second message indicating an increase in bandwidth from a first bandwidth to a second bandwidth, the increase in bandwidth based on a timing advance obtained by processing the first message, receiving, from the device, a third message, the third message employing the second bandwidth and processing the third message to determine whether the communication with the device is via a Reconfigurable Intelligent Surface (RIS). Further aspects of the present disclosure related to an apparatus including a processor caused to carry out this method and a computer-readable medium for causing a processor to carry out this method.

According to an aspect of the present disclosure, there is provided a method. The method includes transmitting, to a network element, a first message, receiving, from the network element, a second message, the second message indicating an increase in bandwidth from a first bandwidth to a second bandwidth, the increase in bandwidth based on a timing advance obtained by the network element processing the first message and transmitting, to the network element, a third message, the third message employing the second bandwidth. Further aspects of the present disclosure related to an apparatus including a processor caused to carry out this method and a computer-readable medium for causing a processor to carry out this method.

According to an aspect of the present disclosure, there is provided a method. The method includes transmitting, to a Reconfigurable Intelligent Surface (RIS), instructions specifying: a first mode for a first resource; and a second mode for a second resource. The method further includes transmitting, to a device, a system information block (SIB), the SIB including an indicator representative of an instruction to: transmit a first message on a first occasion, the first occasion corresponding to the first resource; and transmit a second message on a second occasion, the second occasion corresponding to the second resource. The method further includes receiving, on one occasion, the first message, determining whether the second message has been received and determining, responsive to the determining whether the second message has been received, whether the RIS was involved in communication with the device. Further aspects of the present disclosure related to an apparatus including a processor caused to carry out this method and a computer-readable medium for causing a processor to carry out this method.

According to an aspect of the present disclosure, there is provided a method. The method includes receiving, from a network element, a system information block (SIB), the SIB including instructions, according to the instructions, transmitting, to the network element, a first message on a first occasion, the first occasion corresponding to a first resource and according to the instructions, transmitting, to the network element, a second message on a second occasion, the second occasion corresponding to a second resource. Further aspects of the present disclosure related to an apparatus including a processor caused to carry out this method and a computer-readable medium for causing a processor to carry out this method.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a network in which aspects of the present application may find use, the network includes a base station, two Reconfigurable Intelligent Surfaces and a plurality of user equipment;

FIG. 7 illustrates a network in which aspects of the present application may find use, the network includes a base station, eight Reconfigurable Intelligent Surfaces and a plurality of user equipment;

FIG. 8 illustrates a table providing an approximate average percentage of UEs that may receive signals (propagated from the base station towards the Reconfigurable Intelligent Surfaces) from the base station directly and via Reconfigurable Intelligent Surfaces, for the network illustrated in FIG. 7;

FIG. 9 illustrates, in a signal flow diagram, communication between a base station and a user equipment in the presence of a Reconfigurable Intelligent Surface, in accordance with aspects of the present application;

FIG. 10 illustrates, in a signal flow diagram, communication between a base station and a user equipment in the presence of a Reconfigurable Intelligent Surface, in accordance with aspects of the present application;

FIG. 11 illustrates, in a signal flow diagram, communication between a base station and a user equipment in the presence of a Reconfigurable Intelligent Surface, in accordance with aspects of the present application;

FIG. 12 illustrates, in a signal flow diagram, communication between a base station and a user equipment in the presence of a Reconfigurable Intelligent Surface, in accordance with aspects of the present application;

FIG. 13 illustrates, in a signal flow diagram, communication between a base station and a user equipment in the presence of a plurality of Reconfigurable Intelligent Surfaces, in accordance with aspects of the present application;

FIG. 14 illustrates a network in which aspects of the present application may find use, the network includes a base station, two Reconfigurable Intelligent Surfaces and a plurality of user equipment;

FIG. 15 illustrates a network in which aspects of the present application may find use, the network includes three base stations, two Reconfigurable Intelligent Surfaces and a plurality of user equipment;

FIG. 16 illustrates, in a signal flow diagram, communication between a base station and a user equipment in the presence of a Reconfigurable Intelligent Surface, in accordance with aspects of the present application;

FIG. 17 illustrates, in a signal flow diagram, communication between a base station and a user equipment in the presence of a Reconfigurable Intelligent Surface, in accordance with aspects of the present application; and

FIG. 18 illustrates, in a signal flow diagram, communication between a base station and a user equipment in the presence of a Reconfigurable Intelligent Surface, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

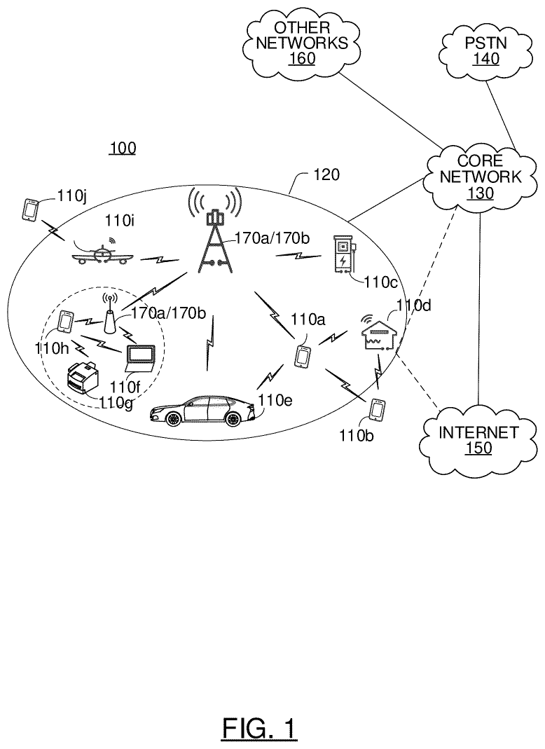

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

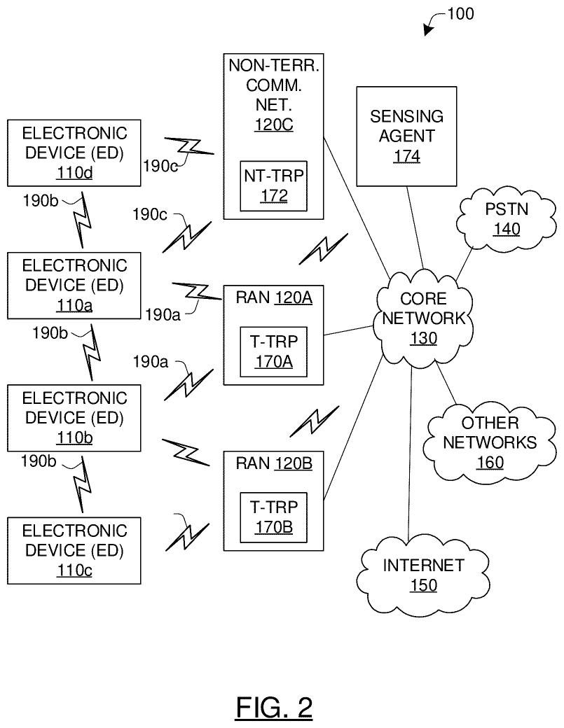

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

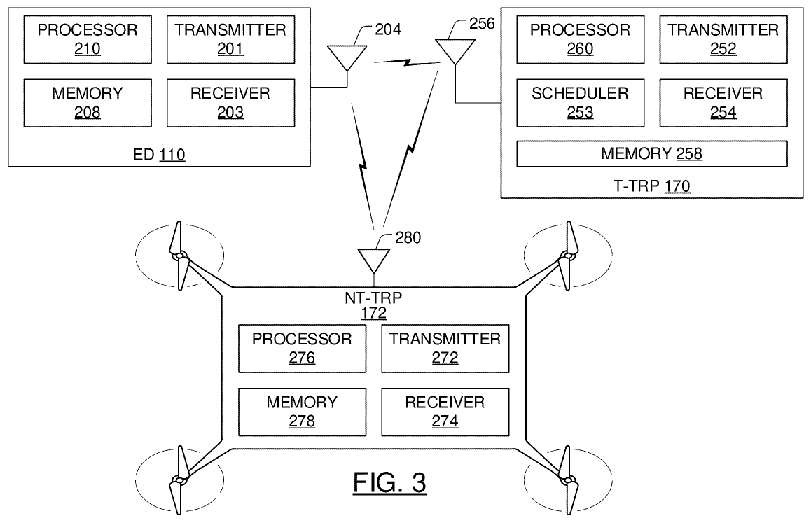

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

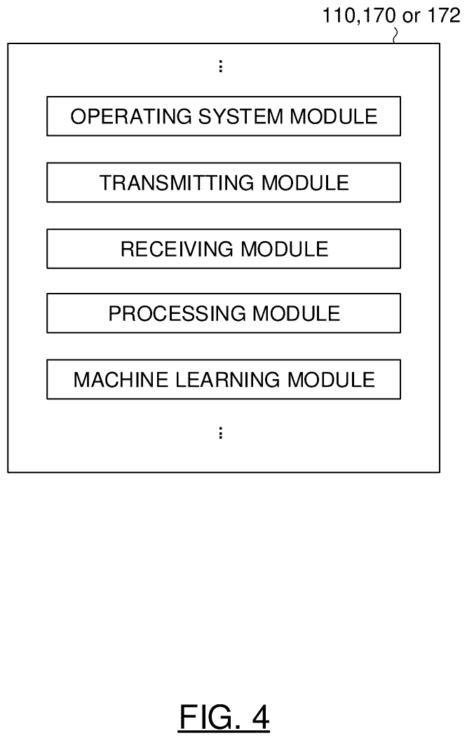

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100.

Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

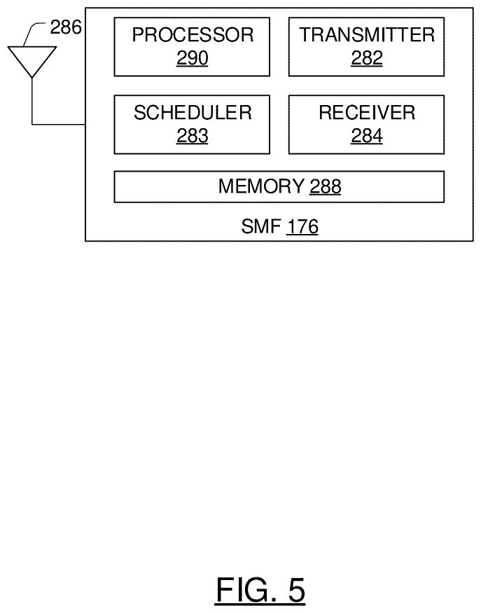

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}-f_{chirp0} and the time duration of the linear chirp signal may be defined as T=t_{chirp1}−t_{chirp0}. Such linear chirp signal can be presented as e^{jπat2} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

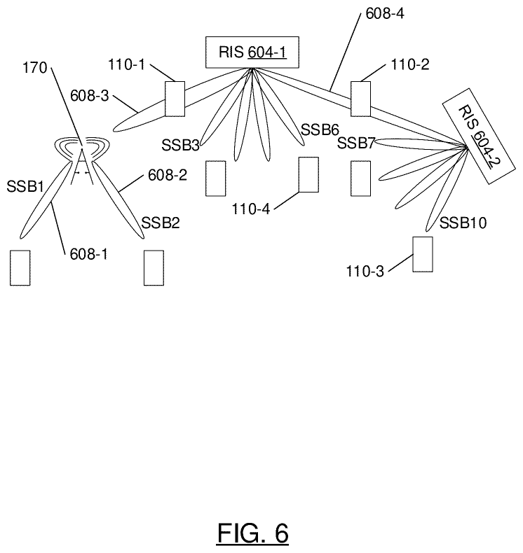

FIG. 6 illustrates a network including a base station 170. FIG. 6 also illustrates a plurality of UEs. In particular, a first UE 110-1, a second UE 110-2, a third 110-3 and a fourth UE 110-4 are associated with specific reference numerals. Several other UEs are represented by rectangles that are not associated with specific reference numerals.

The provision of a first RIS 604-1 and a second RIS 604-2 may be shown to extend coverage provided by the base station 170. The base station 170 is illustrated as transmitting a first SSB (SSB1) in a first beam direction 608-1 and a second SSB (SSB2) in a second beam direction 608-2. In a third beam direction 608-3, toward the first UE 110-1 and the first RIS 604-1, the base station 170 may transmit a plurality of SSBs (e.g., SSB3, . . . , SSB10). The first RIS 604-1 is illustrated as redirecting, as configured, the incident beam in a plurality of directions. Specific SSBs (SSB3, . . . , SSB6) are illustrated as being redirected, by the first RIS 604-1, in distinct beam directions. The first RIS 604-1 is also illustrated as redirecting, as configured, a portion of the incident beam in a fourth beam direction 608-4. In the fourth beam direction 608-4, toward the second UE 110-2 and the second RIS 604-2, the second RIS 604-2 may redirect a plurality of SSBs (e.g., SSB7, . . . , SSB10). Specific SSBs (SSB7, . . . , SSB10) are illustrated as being redirected, by the second RIS 604-2, in distinct beam directions. FIG. 6 illustrates that SSB10 is redirected, by the second RIS 604-2, in a beam direction toward the third UE 110-3.

It is known that, after the base station 170 transmits a plurality of SSBs, a given UE may receive one or more of the SSBs. The given UE may select, from among the plurality of SSBs, an SSB, thereby establishing a selected SSB. The given UE may utilize information carried in the selected SSB when the given UE commences a RACH procedure.

In an arrangement such as that illustrated in FIG. 6, it may be shown that it is useful for the base station 170 to be able to determine whether the given UE has received the selected SSB directly or has received the selected SSB via redirection from one or more of the RIS 604-1, 604-2. It may be further shown that mechanisms are not currently in place to allow the base station 170, or another network element, to determine whether the given UE has received the selected SSB directly or has received the selected SSB via redirection from one or more of the RIS 604-1, 604-2. For clarity, it is notable that aspects of the present application relate to determining that communication with a given UE occurs via one or more of the RIS 604-1, 604-2. Accordingly, such determining is unlikely to be carried out in respect of the UE (not labeled) that directly receives SSB1 in the first beam direction 608-1 and the UE (not labeled) that directly receives SSB2 in the second beam direction 608-2.

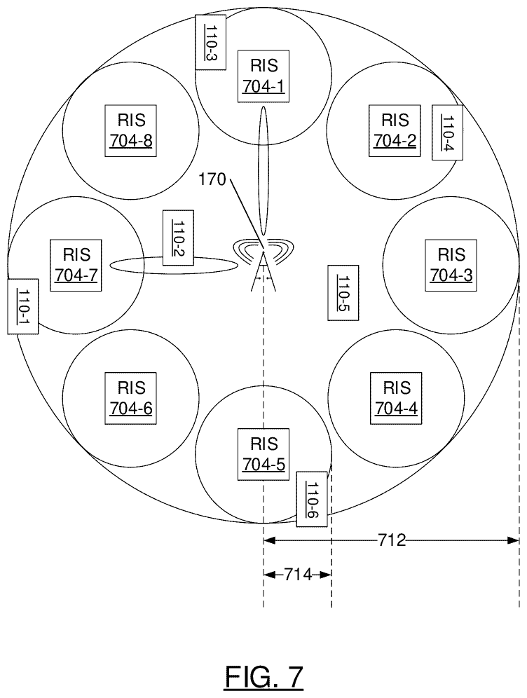

FIG. 7 illustrates network centered around a base station 170. Coverage provided by the base station is illustrated as a circle having a BS radius 712. The BS radius 712 may, for example, have a value of 20 meters. The network of FIG. 7 also has eight RIS 704-1, 704-2, 704-3, 704-4, 704-5, 704-6, 704-7, 704-8 (individually or collectively referenced as 704). Coverage provided by each RIS is illustrated as a circle. The circle associated a particular RIS 704-5 is illustrated as having a RIS radius 714. The RIS radius 714 may, for example, have a value of 2.5 meters. The network of FIG. 7 also includes a plurality of UEs 110-1, 110-2, 110-3, 110-4, 110-5, 110-6 (individually or collectively referenced as 110) distributed in a uniform manner. The base station 170 and each RIS 704 may, for example, be deployed at a height of about two meters, while each UE height is assumed to be 1.5 meters.

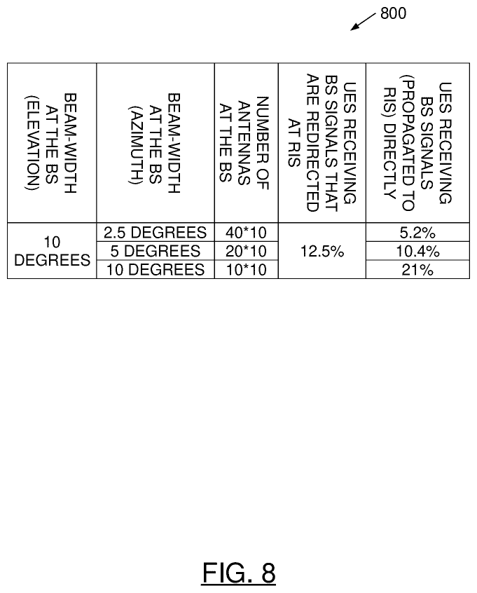

FIG. 8 illustrates a table 800 providing an approximate average percentage of UEs 110 that may receive the signals (propagated from the base station towards RISs) from the BS 170 directly and via RISs 704, for the network illustrated in FIG. 7.

To better utilize a RIS and avoid unnecessary configurations for the RIS, it may be considered of interest to investigate updating the RACH procedure in a manner that allows a base station to determine whether a given UE, from which the BS has received a message specifying an identity of a given SSB, has received the given SSB directly or has received the given SSB via one or more RIS.

In overview, aspects of the present application relate to updating RACH signaling to allow the base station to determine whether a UE is communicating with the base station with help from one or more RIS and/or repeaters. Similarly, updated RACH signaling may be shown to allow the UE to determine whether communication with the base station is occurring with help from one or more RIS and/or repeaters. Without loss of generality, while the next proposed approaches consider RIS in the network, extension to smart repeaters should be considered to be straightforward.

In one example update, the base station may issue an initial uplink grant (or resource allocation) specifying a plurality of time slots. The base station may further configure RIS differently in each time slot. More generically, the base station may issue an initial uplink grant allocating a plurality of resources. Rather than a time slot, a resource may be, for example, a frequency.

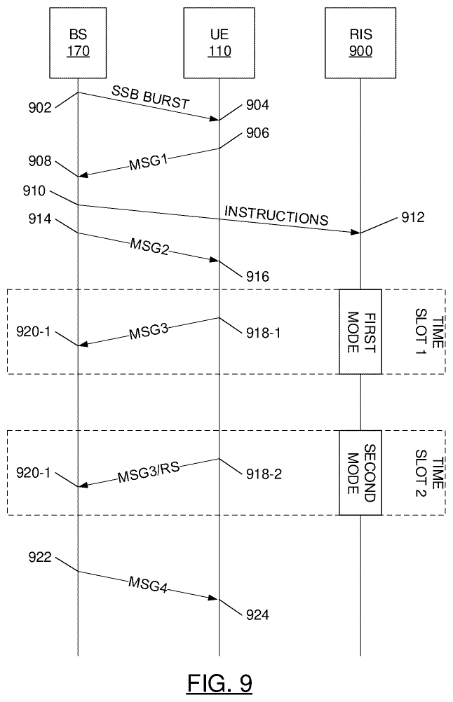

FIG. 9 illustrates, in a signal flow diagram, communication between a BS 170 and a UE 110 in the presence of a RIS 900. In FIG. 9, the BS 170 communicates directly with the UE 110, that is, without use of the RIS 900.

As is routine, the BS 170 may transmit (step 902) an SSB. Upon receipt (step 904) of the SSB, also as is routine, the UE 110 may transmit (step 906) MSG1, a random access request.

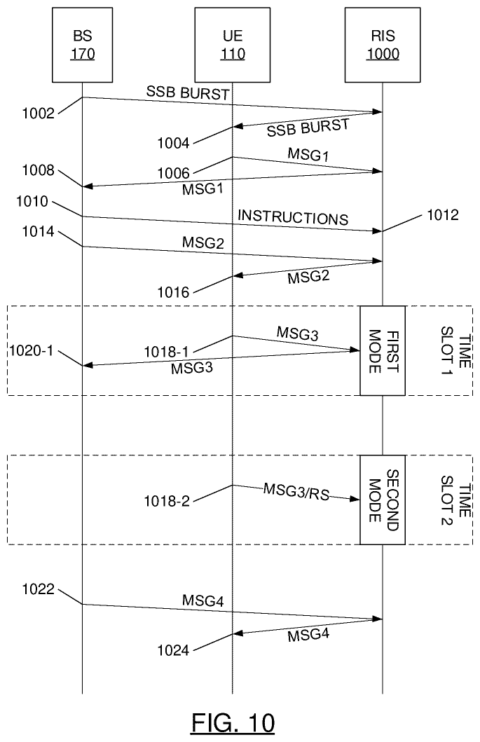

The BS 170 receives (step 908) MSG1. At this point, it may be understood that MSG1 may reach the BS 170 (or other network entity) directly, as illustrated in FIG. 9, or via one or more RIS, as illustrated in FIG. 10.

The BS 170 transmits (step 910), to the RIS 900, instructions, which may also be referred to as configuration, specifying a first mode for the one time slot and a second mode for the other time slot. Upon receiving (step 912) the instructions, the RIS 900 may implement the instructions. In the first mode, the RIS 900 may be configured, by the instructions, to operate in a redirection mode. In the second mode, the RIS 900 may be configured, by the instructions, to operate in an absorption mode. In the second mode, the RIS may be configured, by the instructions, to operate in an improper redirection mode.

Responsive to receiving (step 908) MSG1, the BS 170 may transmit (step 914) MSG2.

To implement the initial uplink grant that specifies a plurality of time slots, it is proposed herein to update MSG2. A first example updated MSG2 includes an instruction indicating that the UE is to transmit one copy of MSG3 in one time slot and another copy of MSG3 in another time slot. A second example updated MSG2 includes an instruction indicating that the UE is to transmit MSG3 in one time slot and a reference signal (RS) in another time slot. The RS in the second example may include no payload. The RS in the second example may use a pre-determined sequence. The RS in the second example may have some payload to allow the base station to identify the UE and/or to deliver some other information.

In aspects of the present application, the first time slot is configured by MSG2. The second time slot may be configured by MSG2 or a message that is distinct from MSG2. Indeed, since the second time slot may be configured relative to the first time slot (e.g., by a defined amount of delay), the second time slot may be configured by a message that is received before MSG3. For example, the second time slot may be configured by a SIB or by RRC signaling.

In FIG. 9, the UE 110 is illustrated as receiving (step 916) MSG2. As configured in the initial uplink grant, the UE 110 transmits (step 918-1) MSG3, a connection request, in time slot 1 and transmits (step 918-2) MSG3 or a RS in time slot 2. Correspondingly, the BS 170 receives (step 920-1) the MSG3 that was transmitted (step 918-1) in time slot 1 and receives (step 920-2) the MSG3 or RS that was transmitted (step 918-2) in time slot 2.

Based upon reception (step 920-1, step 920-2), at the BS 170, of MSG3 and/or RS, transmitted by the UE 110 in one or more time slots, the BS 170, or another network entity, may determine whether communication with the UE 110 is to be carried out with or without help from one or more RIS.

As a matter of course, the BS 170 transmits (step 922) MSG4 to the UE 110. As adapted according to aspects of the present application, MSG4 may include information indicating whether communication with the UE 110 is to be carried out with or without help from one or more RIS. MSG4 is a contention resolution message. MSG4 may also include RRC connection setup information. In the scenario presented in FIG. 9, MSG4 is expected to include information indicating that communication with the UE 110 is to be carried out without help from the RIS 900. The UE 110 receives (step 924) MSG4 and processes the information indicating that communication with the UE 110 is to be carried out without help from the RIS 900. Notably, it is optional to transmit a message indicating that communication with the UE 110 is to be carried out without help from the RIS 900.

FIG. 10 illustrates, in a signal flow diagram, communication between a BS 170 and a UE 110 in the presence of a RIS 1000. In FIG. 10, the BS 170 communicates with the UE 110 through use of the RIS 1000.

As is routine, the BS 170 may transmit (step 1002) an SSB. As illustrated in FIG. 10, the SSB arrives at the UE 110 after a reflection at the RIS 1000. Upon receipt (step 1004) of the SSB, also as is routine, the UE 110 may transmit (step 1006) MSG1, a random access request. As illustrated in FIG. 10, MSG1 arrives at the BS 170 after a reflection at the RIS 1000.

The BS 170 receives (step 1008) MSG1. At this point, it may be understood that MSG1 may reach the BS 170 (or other network entity) directly, as illustrated in FIG. 9, or via one or more RIS, as illustrated in FIG. 10.

The BS 170 transmits (step 1010), to the RIS 1000, instructions specifying a first mode for the one time slot and a second mode for the other time slot. Upon receiving (step 1012) the instructions, the RIS 1000 may implement the instructions. In the first mode, the RIS 1000 may be configured, by the instructions, to operate in a redirection mode. In the second mode, the RIS 1000 may be configured, by the instructions, to operate in an absorption mode. In the second mode, the RIS 1000 may be configured, by the instructions, to operate in an improper redirection mode.

Responsive to receiving (step 1008) MSG1, the BS 170 may transmit (step 1014) MSG2. As illustrated in FIG. 10, MSG2 arrives at the UE 110 after a reflection at the RIS 1000.

To implement the initial uplink grant that specifies a plurality of time slots, it is proposed herein to update MSG2. A first example updated MSG2 includes an instruction indicating that the UE is to transmit MSG3 in one time slot and MSG3 in another time slot. A second example updated MSG2 includes an instruction indicating that the UE is to transmit MSG3 in one time slot and a reference signal (RS) in another time slot. The RS in the second example may include no payload. The RS in the second example may use a pre-determined sequence. The RS in the second example may have some payload to allow the base station to identify the UE.

In FIG. 10, the UE 110 is illustrated as receiving (step 1016) MSG2. As configured in the initial uplink grant, the UE 110 transmits (step 1018-1) MSG3, a connection request, in time slot 1 and transmits (step 1018-2) MSG3 or a RS in time slot 2. In the redirection mode, the RIS 1000 is expected to properly redirect the incident wave carrying MSG3, transmitted (step 1018-1) by the UE 110 in time slot 1, to the BS 170. Correspondingly, the BS 170 receives (step 1020-1) the MSG3 that was transmitted (step 1018-1) in time slot 1.

In the absorption mode, the RIS 1000 is expected to absorb the incident wave carrying MSG3 or the RS, transmitted (step 1018-2) by the UE 110 in time slot 2, such that the wave carrying MSG3 or the RS does not arrive at the BS 170.

In the improper redirection mode, the RIS 1000 is expected to improperly redirect the incident wave carrying MSG3 or the RS, transmitted (step 1018-2) by the UE 110 in time slot 2, such that the wave carrying MSG3 or the RS does not arrive at the BS 170. Here, to improperly redirect the incident wave may be understood to mean that, although the incident wave is redirected, little of the signal level of the wave transmitted by the UE 110 in time slot 2, if any, is received at the BS 170. Indeed, the portion of the wave, transmitted by the UE 110 in time slot 2, that is received by the BS 170 may be negligible compared to noise and interference.

Based upon reception (step 1020-1), at the BS 170, of MSG3 in time slot 1, and non-reception, at the BS 170, of MSG3 and/or RS, transmitted (step 1018-2) by the UE 110 in time slot 2, the BS 170, or another network entity, may determine that communication with the UE 110 is to be carried out with or without help from one or more RIS. With non-reception at time slot 2, the communication is with the help from the RIS.

As a matter of course, the BS 170 transmits (step 1022) MSG4 to the UE 110. As adapted according to aspects of the present application, MSG4 may include information indicating whether communication with the UE 110 is to be carried out with or without help from one or more RIS. MSG4 is a contention resolution message. MSG4 may also include RRC connection setup information. In the scenario presented in FIG. 10, MSG4 is expected to include information indicating that communication with the UE 110 is to be carried out with help from the RIS 1000. As illustrated in FIG. 10, MSG4 arrives at the UE 110 after a reflection at the RIS 1000. The UE 110 receives (step 1024) MSG4 and processes the information indicating that communication with the UE 110 is to be carried out with help from the RIS 1000. Notably, it is optional to transmit a message indicating that communication with the UE 110 is to be carried out with help from the RIS 1000.

While FIGS. 9 and 10 provide signaling considering four-step RACH procedure, it should be noted that it is straightforward to extend the solution to a two-step RACH procedure. For example, in a two-step RACH procedure, MsgA can be represented as a combination of MSG1 and MSG3 that includes PRACH-preamble transmission and MsgA-PUSCH transmission while MsgB can be represented as a combination of MSG2 and MSG4. Using SIB1, or any other SIB (before RACH) or via RRC signaling, it is possible to inform the UE 110 to transmit MsgA over two time slots (or MsgA in one time slot and a reference signal in another time slot) while the network, or BS 170, configures the RIS 900/1000 for proper redirection in one time slot and absorption mode (or improper redirection) in another time slot. The UE 110 may learn the time slots for two uplink transmissions as a pair configured by SIB or RRC. Moreover, the dual uplink transmission of this solution may be applicable to only a subset of SSB indices and, if the UE 110 responds to other SSB indices, the default RACH procedure communication may occur. Then, similar to the examples in FIGS. 9 and 10, based on the reception of MsgA (or MsgA and a reference signal) over two time slots, the network (or the BS 170) may determine whether communication with the UE 110 is to be carried out with or without help from the RIS 900/1000. It may also be considered to be straightforward to extend this solution, with two time slots in view of one RIS 900/1000 between the BS 170 and the UE 110, to a new solution, with more than two time slots in view of more than one RIS 900/1000 between the BS 170 and the UE 110. The extension of this solution to a non-contention RACH procedure may also be considered to be straightforward.

For example, in some scenarios where there may be K (K is a positive integer) RISs between a BS and a UE (e.g., FIG. 6 shows a scenario of two RISs), the BS transmits MSG2 that includes instruction for the UE to transmit MSG3 (or a RS) over K+1 time slots. In each time slot, the RISs are configured to all be in absorption mode, all be in proper redirection mode (e.g., each RIS redirects incident signal from a UE, or a RIS, to another RIS or a BS), or some RISs are configured to be in absorption mode and the other RISs are configured to be in proper redirection mode. Then, from the signals received in one or more time slots, the BS may determine whether communication with the UE is to be carried out with or without help from one or more RIS.

In another example update, the base station may configure RIS differently in each time slot. This time, however, the base station may transmit MSG2 in each time slot of a plurality of time slots.

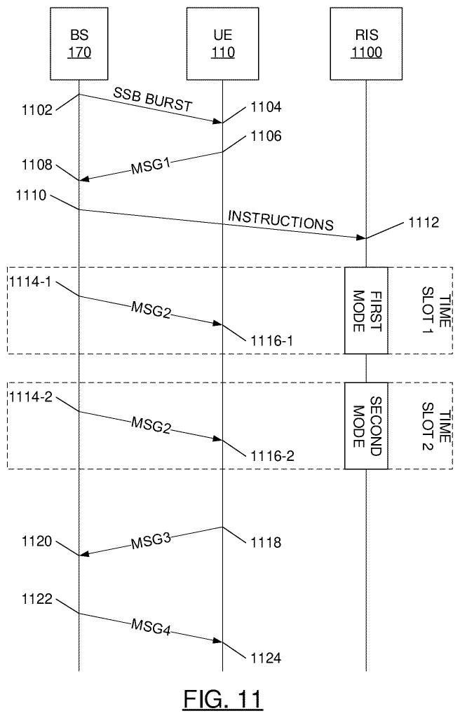

FIG. 11 illustrates, in a signal flow diagram, communication between a BS 170 and a UE 110 in the presence of a RIS 1100. In FIG. 11, the BS 170 communicates directly with the UE 110, that is, without use of the RIS 1100.

As is routine, the BS 170 may transmit (step 1102) an SSB. Upon receipt (step 1104) of the SSB, also as is routine, the UE 110 may transmit (step 1106) MSG1, a random access request.

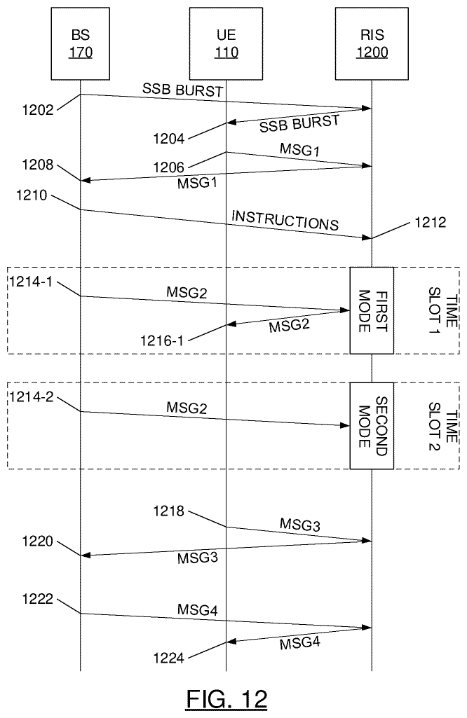

The BS 170 receives (step 1108) MSG1. At this point, it may be understood that MSG1 may reach the BS 170 (or other network entity) directly, as illustrated in FIG. 11, or via one or more RIS, as illustrated in FIG. 12.

The BS 170 transmits (step 1110), to the RIS 1100, instructions specifying a first mode for the one time slot and a second mode for the other time slot. Upon receiving (step 1112) the instructions, the RIS 1100 may implement the instructions. In the first mode, the RIS 1100 may be configured, by the instructions, to operate in a redirection mode. In the second mode, the RIS 1100 may be configured, by the instructions, to operate in an absorption mode. Configuration and instructions from the BS/network to the RIS may be carried via RRC signaling.

Responsive to receiving (step 1108) MSG1, the BS 170 may transmit (step 1114-1) MSG2 in time slot 1 and may transmit (step 1114-2) MSG2 in time slot 2.

In FIG. 11, the UE 110 is illustrated as receiving (step 1116-1) MSG2 in time slot 1 and as receiving (step 1116-2) MSG2 in time slot 2.

It is proposed herein to update MSG3. An example updated MSG3 includes an indication of one or more receptions of MSG2. The UE 110 transmits (step 1118) MSG3, a connection request. In the scenario of FIG. 11, the UE 110 includes, in MSG3, an indication indicating that MSG2 has been received twice.

The BS 170 receives (step 1120) MSG3. Based upon the indication, by the UE 110 in MSG3, the BS 170, or another network entity, may determine whether communication with the UE 110 is to be carried out with or without help from one or more RIS.

As a matter of course, the BS 170 transmits (step 1122) MSG4 to the UE 110. As adapted according to aspects of the present application, MSG4 may include information indicating whether communication with the UE 110 is to be carried out with or without help from one or more RIS. MSG4 is a contention resolution message. MSG4 may also include RRC connection setup information. In the scenario presented in FIG. 11, MSG4 is expected to include information indicating that communication with the UE 110 is to be carried out without help from the RIS 1100. The UE 110 receives (step 1124) MSG4 and processes the information indicating that communication with the UE 110 is to be carried out without help from the RIS 1100. Notably, it is optional to transmit a message indicating that communication with the UE 110 is to be carried out without help from the RIS 1100.

FIG. 12 illustrates, in a signal flow diagram, communication between a BS 170 and a UE 110 in the presence of a RIS 1200. In FIG. 12, the BS 170 communicates with the UE 110 through use of the RIS 1200.

As is routine, the BS 170 may transmit (step 1202) an SSB. As illustrated in FIG. 12, the SSB arrives at the UE 110 after a reflection at the RIS 1200. Upon receipt (step 1204) of the SSB, also as is routine, the UE 110 may transmit (step 1206) MSG1, a random access request. As illustrated in FIG. 12, MSG1 arrives at the BS 170 after a reflection at the RIS 1200.

The BS 170 receives (step 1208) MSG1. At this point, it may be understood that MSG1 may reach the BS 170 (or other network entity) directly, as illustrated in FIG. 11, or via one or more RIS, as illustrated in FIG. 12.

The BS 170 transmits (step 1202), to the RIS 1200, instructions specifying a first mode for the one time slot and a second mode for the other time slot. Upon receiving (step 1212) the instructions, the RIS 1200 may implement the instructions. In the first mode, the RIS 1200 may be configured, by the instructions, to operate in a redirection mode. In the second mode, the RIS 1200 may be configured, by the instructions, to operate in absorption mode.

Responsive to receiving (step 1208) MSG1, the BS 170 may transmit (step 1214-1) MSG2 in time slot 1 and may transmit (step 1214-2) MSG2 in time slot 2.

In FIG. 12, the UE 110 is illustrated as receiving (step 1216-1) MSG2 in time slot 1 and as not receiving anything in time slot 2.

In the redirection mode, the RIS 1200 is expected to properly redirect the incident wave carrying MSG2, transmitted (step 1214-1) by the BS 170 in time slot 1, to the UE 110.

In the absorption mode, the RIS 1200 is expected to absorb the incident wave carrying MSG2, transmitted (step 1214-1) by the BS 170 in time slot 2, such that the wave carrying MSG2 does not arrive at the UE 110.

It is proposed herein to update MSG3. An example updated MSG3 includes an indication of one or more receptions of MSG2. The UE 110 transmits (step 1218) MSG3, a connection request. In the scenario of FIG. 12, the UE 110 includes, in MSG3, an indication indicating that MSG2 has been received once.

The BS 170 receives (step 1220) MSG3 that was transmitted (step 1218).

Based upon the indication, by the UE 110 in MSG3, the BS 170, or another network entity, may determine whether communication with the UE 110 is to be carried out with or without help from one or more RIS.

As a matter of course, the BS 170 transmits (step 1222) MSG4 to the UE 110. As adapted according to aspects of the present application, MSG4 may include information indicating whether communication with the UE 110 is to be carried out with or without help from one or more RIS. MSG4 is a contention resolution message. MSG4 may also include RRC connection setup information. In the scenario presented in FIG. 12, MSG4 is expected to include information indicating that communication with the UE 110 is to be carried out with help from the RIS 1200. As illustrated in FIG. 12, MSG4 arrives at the UE 110 after a reflection at the RIS 1200. The UE 110 receives (step 1224) MSG4 and processes the information indicating that communication with the UE 110 is to be carried out with help from the RIS 1200. Notably, it is optional to transmit a message indicating that communication with the UE 110 is to be carried out with help from the RIS 1200.

While FIGS. 11 and 12 provide signaling considering four-step RACH procedure, it should be noted that it is straightforward to extend the solution to a two-step RACH procedure. Using SIB1, or any other SIB (before RACH) or via RRC signaling, it is possible to inform the UE 110 that MsgB will be sent over two time slots (where the delay between the two time slots can be also informed in SIB or via RRC signaling) or MsgB in one time slot and a reference signal in another time slot. The network, or the BS 170, further configures the RIS 1100/1200 for proper redirection in one time slot and absorption mode (or improper redirection) in another time slot. Then, similar to the examples in FIGS. 11 and 12, based on the ACK/NACK feedback from the UE 110 for MsgB (or MsgB and a reference signal) over two time slots, the network (or the BS 170) may determine whether communication with the UE 110 is to be carried out with or without help from the RIS 1100/1200. Alternatively, a subsequent uplink signaling not using ACK/NAK signaling to inform the network about reception of one or both MsgB is possible. It may also be considered to be straightforward to extend this solution, with two time slots in view of one RIS 1100/1200 between the BS 170 and the UE 110, to a new solution, with more than two time slots in view of more than one RIS 1100/1200 between the BS 170 and the UE 110.

For example, in some scenarios where there may be K (K is a positive integer) RISs between a BS and a UE (e.g., FIG. 6 shows a scenario of two RISs), the BS transmits MSG2 that includes instruction for the UE to transmit MSG3 (or a RS) over K+1 time slots. In each time slot, the RISs are configured to all be in absorption mode, all be in proper redirection mode (e.g., each RIS redirects incident signal from a UE, or a RIS, to another RIS or a BS), or some RISs are configured to be in absorption mode and the other RISs are configured to be in proper redirection mode. Then, the UE sends MSG3 with the indication about one or more receptions of MSG2. Such an indication may be understood to help the BS determine whether communication with the UE is to be carried out with or without help from one or more RISs.

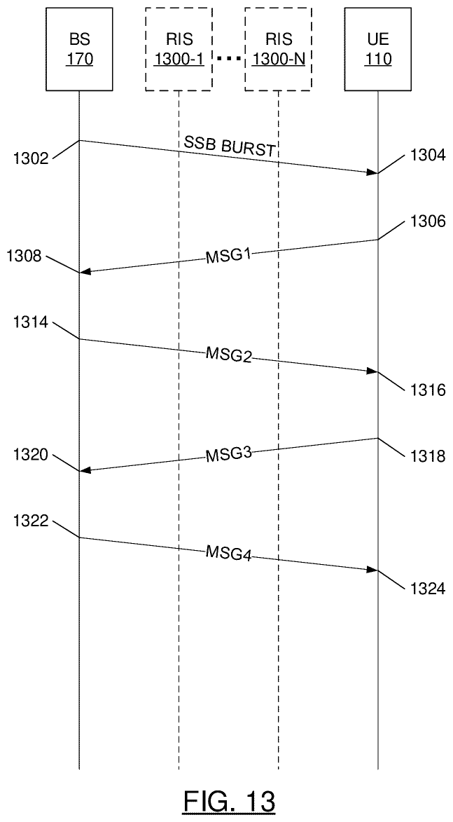

FIG. 13 illustrates, in a signal flow diagram, communication between a BS 170 and a UE 110 in the potential presence of a plurality of RIS 1300-1, . . . , 1300-N (collectively or individually 1300). In FIG. 13, the BS 170 may communicate with the UE 110 through use of one RIS 1300, more than one RIS 1300 or no RIS 1300.

As is routine, the BS 170 may transmit (step 1302) an SSB. Upon receipt (step 1304) of the SSB, also as is routine, the UE 110 may transmit (step 1306) MSG1, a random access request. In the event that the UE 110 receives (step 1304) a plurality of SSBs, the UE 110 may select one SSB (a “selected SSB”) among the plurality of SSBs. As discussed hereinbefore, the UE 110 may select a preamble (a “selected preamble”) that corresponds to the selected SSB. As part of transmitting (step 1306) MSG1, the UE 110 may include, in MSG1, the selected preamble.

As part of transmitting (step 1306) MSG1, the UE 110 may include an indication of a beam index associated with the selected SSB. Indeed, even when there is only one SSB received at the UE 110, the UE 110 may include an indication of a beam index associated with the one SSB as the selected SSB. Notably, the RACH occasions (i.e., time and frequency resources) to send MSG1 are associated with each SSB. Hence, based on RACH occasion during which the BS receives MSG1, the BS may know the SSB index received at the UE.

The BS 170 receives (step 1308) MSG1. At this point, it may be understood that MSG1 may reach the BS 170 (or other network entity) directly, as illustrated in FIG. 13, or via one or more RIS 1300.

Upon receiving (step 1308) MSG1, the BS 170, or another network element, may determine, from an indication included in MSG1, the beam index of the SSB that has been selected by the UE 110. The beam index, alone, may be enough information to allow the BS 170 to determine that the UE 110 has received the selected SSB directly (no RIS 1300), through use of one RIS 1300 or through use of more than one RIS 1300.

Responsive to the BS 170 determining that the UE 110 has received the selected SSB through use of more than one RIS 1300, the BS 170 may configure the more than one RIS 1300 such that the more than one RIS 1300 properly redirects MSG2 and/or MSG3. The configuration of the more than one RIS 1300 may, for example, take into account that the incident signal and the redirected signal for the more than one RIS 1300 are to be the same as the incident signal and the redirected signal for related to the SSB that has been selected by the UE 110.

To allow the BS 170 to obtain RIS-related information from the UE 110, it is proposed herein to update MSG2 to include a request for information from the UE 110. In particular, the BS 170 may transmit (step 1314) MSG2 including a request that the UE 110 indicate measurement information, collected by the UE 110, about a set of received SSBs (one SSB or more than one SSB).

The measurement information may include an indication of an index associated with each SSB in the set of SSBs that have been received, by the UE 110, with “proper” strength and using the same or similar receive directions. A proper strength may be defined as a strength that exceeds a predetermined threshold. The same or similar receive directions may be defined as a range of angles (azimuth and/or elevation).

The measurement information may include an indication of a signal strength associated with each SSB in the set of SSBs that have been received, by the UE 110, with “proper” strength and using the same or similar receive directions.

The signal strength, indicated by the UE 110, may include one or more of reference signal received power (RSRP), received signal strength indicator (RSSI) and signal-to-noise ratio (SNR). Other values that are indicative of signal strength are also contemplated.

The measurement information may include an indication of a direction or a physical cell identification.

Upon receiving (step 1316) MSG2, the UE 110 transmits (step 1318) MSG3. Responsive to the request included with MSG2, the UE 110 may include, in MSG3, SSB measurement information. Notably, in the case of the two-step RACH procedure, MsgA may be understood to include, in its payload, SSB measurement information.

The BS 170 receives (step 1320) MSG3. Based upon the SSB measurement information, included by the UE 110 in MSG3, the BS 170, or another network entity, may determine whether communication with the UE 110 is to be carried out with or without help from one or more RIS 1300.

As a matter of course, the BS 170 transmits (step 1322) MSG4 to the UE 110. As adapted according to aspects of the present application, MSG4 may include information indicating whether communication with the UE 110 is to be carried out with or without help from one or more RIS. MSG4 is a contention resolution message. MSG4 may also include RRC connection setup information. The UE 110 receives (step 1324) MSG4 and processes the information indicating that communication with the UE 110 is to be carried out with or without help from one or more RIS 1300. Notably, it is optional to transmit a message indicating that communication with the UE 110 is to be carried out with or without help from one or more RIS 1300.

Consider the network illustrated in FIG. 6 and, in particular, the case of the first UE 110-1, the case of the second UE 110-2 and the case of the third UE 110-3.

A given UE 110 receives (step 1308) a plurality of SSBs. The given UE 110 then selects one SSB (e.g., SSB10) among the plurality of SSBs. As part of transmitting (step 1306) MSG1, the given UE 110 may include a selected preamble, wherein the selected preamble is associated with the selected SSB (e.g., SSB10). As part of transmitting (step 1306) MSG1, the UE 110 may include an indication of a beam index (e.g., beam index 47) associated with the selected SSB (e.g., SSB10).

Upon receiving (step 1308) MSG1, the BS 170 may determine that the preamble included in MSG1 is associated with SSB10. It follows that, upon receiving (step 1308) MSG1, the BS 170 may determine that the beam index of the SSB that has been selected by the first UE 110-1 is beam index 47. The BS 170 may, further, determine that the index (SSB10) of the selected SSB, alone, is insufficient information to allow the BS 170 to determine that the given UE 110 has received the selected SSB, SSB10, directly (no RIS 1300) or through use of one or more RIS 1300. Indeed, there exists some ambiguity regarding whether the given UE 110 that has reported having selected SSB10 is in the position of the first UE 110-1, the position of the second UE 110-2 or in the position of the third UE 110-3.

The BS 170 may configure the more than one RIS 1300 such that the more than one RIS 1300 properly redirects MSG2 and/or MSG3. The configuration of the more than one RIS 1300 may, for example, take into account that the incident signal and the redirected signal for the more than one RIS 1300 are to be the same as the incident signal and the redirected signal for related to the SSB (SSB10) that has been selected by the UE 110.

The BS 170 may transmit (step 1314) MSG2 including a request that the given UE 110 indicate measurement information, collected by the given UE 110, about a set of received SSBs (one SSB or more than one SSB).

Responsive to receiving (step 1316) MSG2 adapted, according to aspects of the present application, to include a request for SSB measurement information, the given UE 110 transmits (step 1318) MSG3 including SSB measurement information.

For one example, the SSB measurement information, requested by the BS 170 in MSG2, may include an indication of an index for each received SSB among the plurality of SSBs.

In the case wherein the given UE 110 is the first UE 110-1, the first UE 110-1 may indicate, in MSG3, indices for SSB3, SSB4, SSB5, SSB6, SSB7, SSB8, SSB9 and SSB10. In the case wherein the given UE 110 is the second UE 110-2, the second UE 110-2 may indicate, in MSG3, indices for SSB7, SSB8, SSB9 and SSB10. In the case wherein the given UE 110 is the third UE 110-3, the third UE 110-3 may indicate, in MSG3, the index for SSB10.

For another example, the SSB measurement information, requested by the BS 170 in MSG2, may include an indication of signal strength information for specifically indicated SSBs. The BS 170 may include, in MSG2, a request for signal strength information for SSB4, SSB8 and SSB10.

In the case wherein the given UE 110 is the first UE 110-1, the first UE 110-1 may indicate, in MSG3, that SSB4, SSB8 and SSB10 have all been received with proper strength. In the case wherein the given UE 110 is the second UE 110-2, the second UE 110-2 may indicate, in MSG3, that SSB4 was not received with proper strength while SSB8 and SSB10 have been received with proper strength. In the case wherein the given UE 110 is the third UE 110-3, the third UE 110-3 may indicate, in MSG3, that SSB4 and SSB8 were not received with proper strength while SSB10 has been received with proper strength.

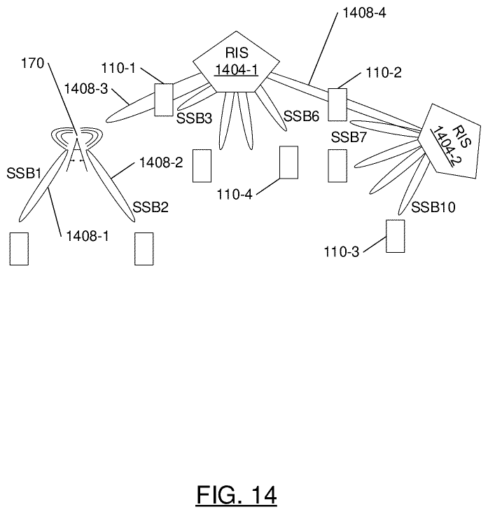

FIG. 14 illustrates a base station 170. FIG. 14 also illustrates a plurality of UEs. In particular, a first UE 110-1, a second UE 110-2, a third 110-3 and a fourth UE 110-4 are associated with specific reference numerals. Several other UEs are represented by rectangles that are not associated with specific reference numerals.

The provision of a first RIS 1404-1 and a second RIS 1404-2 may be shown to extend coverage provided by the base station 170.

The first RIS 1404-1 and the second RIS 1404-2 of FI. 14 may be understood to be distinct from the first RIS 604-1 and the second RIS 604-2 of FIG. 6 in that the first RIS 1404-1 and the second RIS 1404-2 of FIG. 14 are implemented as multi-RIS structures, each of which may also be referenced as an “RIS box.” For a multi-RIS structure 1404, it may be shown that a redirected signal may depart the multi-RIS structure 1404 at an angle similar to the angle at which an incident signal arrived at the multi-RIS structure 1404. It follows that a given SSB may be received, at a given UE, via different directions.

The base station 170 is illustrated as transmitting a first SSB (SSB1) in a first beam direction 1408-1 and a second SSB (SSB2) in a second beam direction 1408-2. In a third beam direction 1408-3, toward the first UE 110-1 and the first RIS 1404-1, the base station 170 may transmit a plurality of SSBs (e.g., SSB3, . . . , SSB10). The first RIS 1404-1 is illustrated as redirecting, as configured, the incident beam in a plurality of directions. Specific SSBs (SSB3, . . . , SSB6) are illustrated as being redirected, by the first RIS 1404-1, in distinct beam directions. The first RIS 1404-1 is also illustrated as redirecting, as configured, a portion of the incident beam in a fourth beam direction 1408-4. In the fourth beam direction 1408-4, toward the second UE 110-2 and the second RIS 1404-2, the second RIS 1404-2 may redirect a plurality of SSBs (e.g., SSB7, . . . , SSB10). Specific SSBs (SSB7, . . . , SSB10) are illustrated as being redirected, by the second RIS 1404-2, in distinct beam directions. FIG. 14 illustrates that SSB10 is redirected, by the second RIS 1404-2, in a beam direction toward the third UE 110-3.

For a further example, the SSB measurement information, requested by the BS 170 in MSG2, may include an indication of one or more directions of receiving specific SSBs. The BS 170 may, for example, include, in MSG2, a request for an indication of one or more directions of receiving SSB3 and SSB7.

In the case wherein the given UE 110 is the first UE 110-1 of FIG. 14, the first UE 110-1 may indicate, in MSG3, that SSB3 has been received via two directions. The first UE 110-1 may indicate an angle-of-incidence (AoI) representative of each of the two directions over which SSB3 has been received. Alternatively, the first UE 110-1 may indicate a function of the AoI representative of each of the two directions over which SSB3 has been received. An example function is a difference (e.g., AoI₂−AoI₁). The first UE 110-1 may further indicate that SSB7 has been received via one direction.

In the case wherein the given UE 110 is the second UE 110-2 of FIG. 14, the second UE 110-2 may indicate, in MSG3, that SSB3 has not been received. The second UE 110-2 may further indicate that SSB7 has been received via two directions. The second UE 110-2 may indicate an AoI representative of each of the two directions over which SSB7 has been received. Alternatively, the second UE 110-2 may indicate a function of the AoI representative of each of the two directions over which SSB7 has been received. An example function is a difference (e.g., AoI₂−AoI₁).

In the case wherein the given UE 110 is the third UE 110-3 of FIG. 14, the third UE 110-3 may indicate, in MSG3, that SSB3 has not been received and SSB7 has not been received.

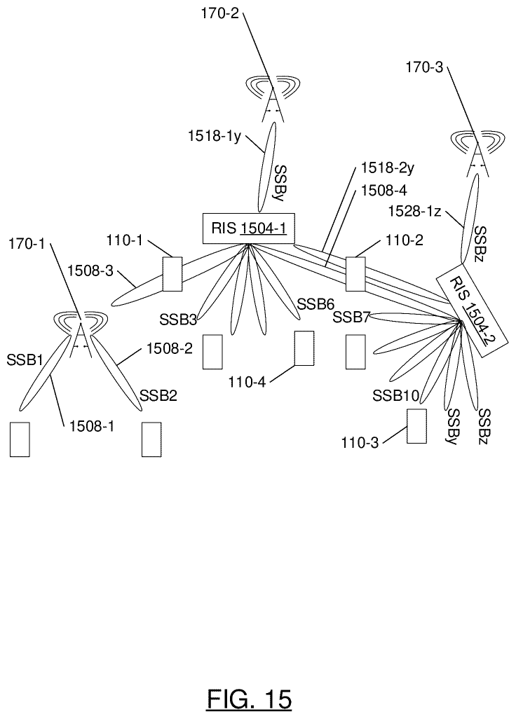

FIG. 15 illustrates a first base station 170-1. FIG. 6 also illustrates a plurality of UEs. In particular, a first UE 110-1, a second UE 110-2, a third 110-3 and a fourth UE 110-4 are associated with specific reference numerals. Several other UEs are represented by rectangles that are not associated with specific reference numerals.

The provision of a first RIS 1504-1 and a second RIS 1504-2 may be shown to extend coverage provided by the first base station 170-1. The first base station 170-1 is illustrated as transmitting a first SSB (SSB1) in a first beam direction 1508-1 and a second SSB (SSB2) in a second beam direction 1508-2. In a third beam direction 1508-3, toward the first UE 110-1 and the first RIS 1504-1, the first base station 170-1 may transmit a plurality of SSBs (e.g., SSB3, . . . , SSB10). The first RIS 1504-1 is illustrated as redirecting, as configured, the incident beam in a plurality of directions. Specific SSBs (SSB3, . . . , SSB6) are illustrated as being redirected, by the first RIS 1504-1, in distinct beam directions. The first RIS 1504-1 is also illustrated as redirecting, as configured, a portion of the incident beam in a fourth beam direction 1508-4. In the fourth beam direction 1508-4, toward the second UE 110-2 and the second RIS 1504-2, the second RIS 1504-2 may redirect a plurality of SSBs (e.g., SSB7, . . . , SSB10). Specific SSBs (SSB7, . . . , SSB10) are illustrated as being redirected, by the second RIS 1504-2, in distinct beam directions. FIG. 15 illustrates that SSB10 is redirected, by the second RIS 1504-2, in a beam direction toward the third UE 110-3.

FIG. 15 also illustrates a second base station 170-2, which may also be called and “access point,” and a third base station 170-3, which may also be called and “access point.” To allow a receiving device to distinguish the origin of an SSB, a base station 170 may include, in the SSB, a physical cell identifier (“PCID”). For example, the first base station 170-1 may include, in the SSB, PCID1, second base station 170-2 may include, in the SSB, PCID2 and the third base station 170-3 may include, in the SSB, PCID3.

The second base station 170-2 is illustrated as transmitting a y^{th} SSB (SSBy) in a first beam direction 1518-1y. SSBy is illustrated as being redirected, by the first RIS 1504-1, in a second beam direction 1518-2y. SSBy is also illustrated as being redirected, by the second RIS 1504-2.

The third base station 170-3 is illustrated as transmitting a z^{th} SSB (SSBz) in a first beam direction 1528-1z. SSBz is illustrated as being redirected, by the second RIS 1504-2.

For a still further example, the SSB measurement information, requested by the BS 170-1 in MSG2, may include information about SSBy, from the second BS 170-2 with PCID2, and SSBz, from the third BS 170-3 with PCID3.

In the case wherein the given UE 110 is the first UE 110-1 of FIG. 15, the first UE 110-1 may indicate, in MSG3, that SSBy (with PCID2) has not been received and that SSBz (with PCID3) has not been received.

In the case wherein the given UE 110 is the second UE 110-2 of FIG. 15, the second UE 110-2 may indicate, in MSG3, that SSBy (with PCID2) has been received. The second UE 110-2 may further indicate that SSBz (with PCID3) has not been received.

In the case wherein the given UE 110 is the third UE 110-3 of FIG. 15, the third UE 110-3 may indicate, in MSG3, that SSBy (with PCID2) has been received and that SSBz (with PCID3) has been received.

It has been suggested hereinbefore that, to allow the BS 170 to obtain RIS-related information from the UE 110, MSG2 may be updated to include a request for information from the UE 110. As an alternative, the request for information from the UE 110 may be included in a SIB, such as SIB1, which indicates the RACH procedure. That is, an initial message including the request for information from the UE 110 may be included in a system information broadcast message.

For two-step RACH procedure, it should be noted that it is possible to request the UE 110 to send information about one or more SSBs in MsgA by including such a request in SIB1, or any other SIB before RACH, or via RRC signaling. Alternatively, the standard may specify that the UE 110 is to always provide information regarding the set of detected SSBs.

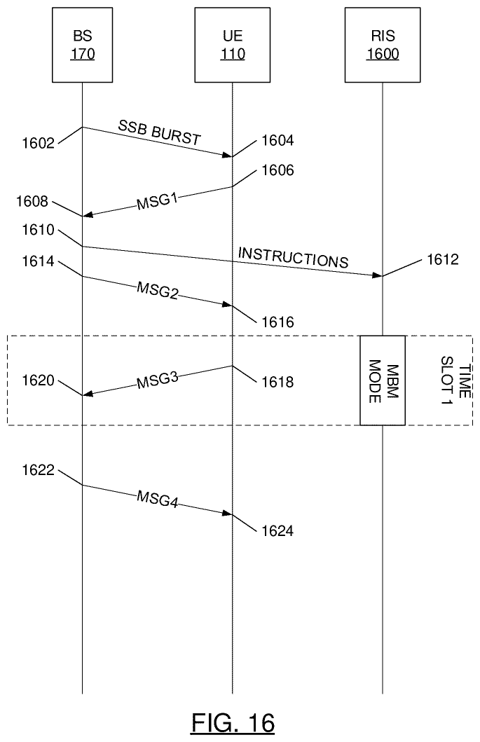

FIG. 16 illustrates, in a signal flow diagram, communication between a BS 170 and a UE 110 in the presence of a RIS 1600. In FIG. 16, the BS 170 communicates directly with the UE 110, that is, without use of the RIS 1600.

As is routine, the BS 170 may transmit (step 1602) a plurality of SSBs. Upon receipt (step 1604) of one of the SSBs, also as is routine, the UE 110 may transmit (step 1606) MSG1, a random access request. Indeed, the UE 110 may receive (step 1604) many SSBs among the plurality of SSBs. It is then a task of the UE 110 to select a particular SSB among the many received SSBs. The UE 110 may then select a preamble corresponding to the selected SSB. It follows that the UE 110 will include, in MSG1, the selected preamble.

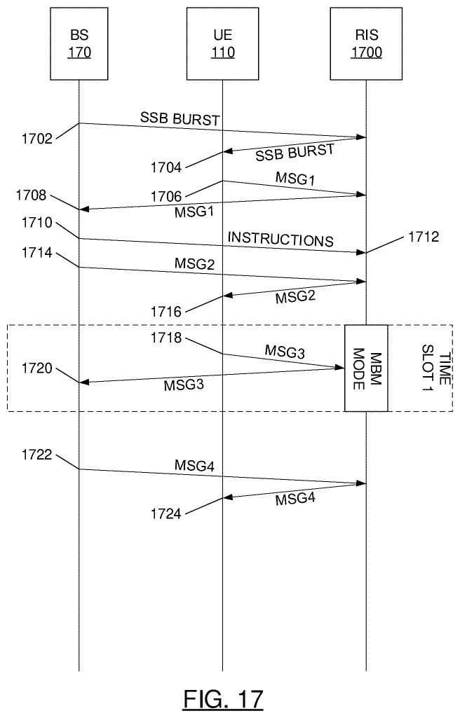

The BS 170 receives (step 1608) MSG1. At this point, it may be understood that MSG1 may reach the BS 170 (or other network entity) directly, as illustrated in FIG. 16, or via one or more RIS, as illustrated in FIG. 17. Upon receiving (step 1608) MSG1, the BS 170, or another network element, may determine, from the preamble in MSG1, the particular SSB that the UE 110 has selected. The BS 170, or another network element, may determine, from the preamble in MSG1, the beam index of the beam over which the particular SSB was received (step 1604) by the UE 110.

Responsive to receiving (step 1608) MSG1, the BS 170 transmits (step 1610), to the RIS 1600, instructions specifying a media-based-modulation (MBM) mode for a time slot. Upon receiving (step 1612) the instructions, the RIS 1600 may implement the instructions. In the MBM mode in time slot 1, the RIS 1600 may be configured to add extra information to a redirected signal by modulating one or more of a phase, a frequency, an amplitude or a polarization of an incident signal. Examples for modulating the incident signal to add extra information (e.g., overlay additional information) may comprise one of: modifying a phase shift of one or more configurable elements of the RIS to modulate at least one of amplitude, phase, frequency, or polarization of the incident signal in order to overlay additional information on the incident signal; or turning one or more configurable elements of the RIS on or off to modulate the amplitude.

BS 170 may then transmit (step 1614) MSG2.

In FIG. 16, the UE 110 is illustrated as receiving (step 1616) MSG2. As discussed hereinbefore, the BS 170 may include, in MSG2, an initial uplink grant. The initial uplink grant may, in this case, specify time slot 1.

In accordance with the initial uplink grant, the UE 110 transmits (step 1618) MSG3, a connection request in time slot 1.

The BS 170 receives (step 1620) MSG3. Based upon a presence or an absence of MBM in the signal that carries MSG3, the BS 170, or another network entity, may determine whether communication with the UE 110 is to be carried out with or without help from one or more RIS.

As a matter of course, the BS 170 transmits (step 1622) MSG4 to the UE 110. As adapted according to aspects of the present application, the BS 170 may include, in MSG4, information indicating whether communication with the UE 110 is to be carried out with or without help from one or more RIS. MSG4 is a contention resolution message. MSG4 may also include RRC connection setup information. In the scenario presented in FIG. 16, MSG4 is expected to include information indicating that communication with the UE 110 is to be carried out without help from the RIS 1600. The UE 110 receives (step 1624) MSG4 and processes the information indicating that communication with the UE 110 is to be carried out without help from the RIS 1600. Notably, it is optional to transmit a message indicating that communication with the UE 110 is to be carried out without help from the RIS 1600.

FIG. 17 illustrates, in a signal flow diagram, communication between a BS 170 and a UE 110 in the presence of a RIS 1700. In FIG. 17, the BS 170 communicates with the UE 110 through use of the RIS 1700.

As is routine, the BS 170 may transmit (step 1702) a plurality of SSBs. As illustrated in FIG. 17, at least one of the SSBs arrives at the UE 110 after a reflection at the RIS 1700. Upon receipt (step 1704) of the SSB, also as is routine, the UE 110 may transmit (step 1706) MSG1, a random access request. Indeed, the UE 110 may receive (step 1704) many SSBs among the plurality of SSBs. It is then a task of the UE 110 to select a particular SSB among the many received SSBs. The UE 110 may then select a preamble corresponding to the selected SSB. It follows that the UE 110 will include, in MSG1, the selected preamble.

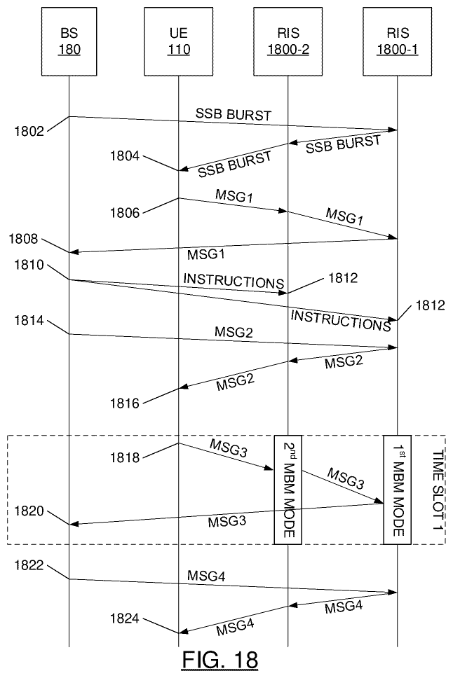

As illustrated in FIG. 17, MSG1 arrives at the BS 170 after a reflection at the RIS 1700. The BS 170 receives (step 1708) MSG1. At this point, it may be understood that MSG1 may reach the BS 170 (or other network entity) directly, as illustrated in FIG. 16, via one RIS, as illustrated in FIG. 17 or via more than one RIS, as illustrated in FIG. 18. Upon receiving (step 1708) MSG1, the BS 170, or another network element, may determine, from the preamble in MSG1, the particular SSB that the UE 110 has selected. The BS 170, or another network element, may determine, from the preamble in MSG1, the beam index of the beam over which the particular SSB was received (step 1704) by the UE 110.

Responsive to receiving (step 1708) MSG1, the BS 170 transmits (step 1710), to the RIS 1700, instructions specifying an MBM mode for a time slot. Upon receiving (step 1712) the instructions, the RIS 1700 may implement the instructions. In the MBM mode, the RIS 1700 may be configured, by the instructions, to add extra information to a redirected signal by modulating one or more of a phase, a frequency, an amplitude or a polarization of an incident signal.

The BS 170 may then transmit (step 1714) MSG2.

In FIG. 17, the UE 110 is illustrated as receiving (step 1716) MSG2 after a reflection at the RIS 1700. As discussed hereinbefore, the BS 170 may include, in MSG2, an initial uplink grant. The initial uplink grant may, in this case, specify time slot 1.

In accordance with the initial uplink grant, the UE 110 transmits (step 1718) MSG3, a connection request in time slot 1.

In the MBM mode, the RIS 1700 is expected to redirect an incident wave carrying MSG3, transmitted (step 1718) by the UE 110 in time slot 1, to the BS 170. While redirecting the incident wave, the RIS 1700 is expected to implement the instructions received in step 1712. That is, the RIS 1700 is expected to modulate one or more of a phase, a frequency, an amplitude or a polarization of an incident signal carrying MSG3.

The BS 170 receives (step 1720) MSG3 that was transmitted (step 1718) by the UE 110 and reflected and modulated at the RIS 1700.

Based upon the modulation, the BS 170, or another network entity, may determine whether communication with the UE 110 is to be carried out with or without help from one or more RIS.

As a matter of course, the BS 170 transmits (step 1722) MSG4 to the UE 110. As adapted according to aspects of the present application, MSG4 may include information indicating whether communication with the UE 110 is to be carried out with or without help from one or more RIS. MSG4 is a contention resolution message. MSG4 may also include RRC connection setup information. In the scenario presented in FIG. 17, MSG4 is expected to include information indicating that communication with the UE 110 is to be carried out with help from the RIS 1700. As illustrated in FIG. 17, MSG4 arrives at the UE 110 after a reflection at the RIS 1700. The UE 110 receives (step 1724) MSG4 and processes the information indicating that communication with the UE 110 is to be carried out with help from the RIS 1700. Notably, it is optional to transmit a message indicating that communication with the UE 110 is to be carried out with help from the RIS 1700.

It should be noted that it is also possible for the network, or the BS 170, to configure the RIS 1700 to redirect incident signals (e.g., MSG1 in the four-step RACH procedure or MsgA in the two-step RACH procedure) with MBM for each SSB that might have RIS in its propagation path.

Notably, it may be considered to be straightforward to extend aspects of the present application to a scenario wherein the BS 170 and the UE 110 communicate via more than one RIS or other type of smart repeater.

For example, consider a scenario presented in FIG. 18, which illustrates, in a signal flow diagram, communication between a BS 170 and a UE 110 in the presence of a first RIS 1800-1 and a second RIS 1800-2. In FIG. 18, the BS 170 communicates with the UE 110 through use of both the first RIS 1800-1 and the second RIS 1800-2.

As is routine, the BS 170 may transmit (step 1802) a plurality of SSBs. As illustrated in FIG. 18, at least one of the SSBs arrives at the UE 110 after a reflection at the first RIS 1800-1 and the second RIS 1800-2. Upon receipt (step 1804) of the SSB, also as is routine, the UE 110 may transmit (step 1806) MSG1, a random access request. Indeed, the UE 110 may receive (step 1804) many SSBs among the plurality of SSBs. It is then a task of the UE 110 to select a particular SSB among the many received SSBs. The UE 110 may then select a preamble corresponding to the selected SSB. It follows that the UE 110 will include, in MSG1, the selected preamble.

As illustrated in FIG. 18, MSG1 arrives at the BS 170 after a reflection at the first RIS 1800-1 and the second RIS 1800-2. At this point, it may be understood that MSG1 may reach the BS 170 (or other network entity) directly, as illustrated in FIG. 16, via one RIS, as illustrated in FIG. 17 or via more than one RIS, as illustrated in FIG. 18. Upon receiving (step 1808) MSG1, the BS 170, or another network element, may determine, from the preamble in MSG1, the particular SSB that the UE 110 has selected. The BS 170, or another network element, may determine, from the preamble in MSG1, the beam index of the beam over which the particular SSB was received (step 1804) by the UE 110.

Responsive to receiving (step 1808) MSG1, the BS 170 transmits (step 1810), to the first RIS 1800-1, instructions specifying a first MBM mode for a time slot. Responsive to receiving (step 1808) MSG1, the BS 170 transmits (step 1810), to the second RIS 1800-2, instructions specifying a second MBM mode for the time slot. Upon receiving (step 1812) the instructions, the first RIS 1800-1 and the second RIS 1800-2 may implement the instructions. In the first MBM mode, the first RIS 1800-1 may be configured, by the instructions, to add first extra information to a redirected signal by modulating one or more of a phase, a frequency, an amplitude or a polarization of an incident signal. In the second MBM mode, the second RIS 1800-2 may be configured, by the instructions, to add second extra information to a redirected signal by modulating one or more of a phase, a frequency, an amplitude or a polarization of an incident signal.

The BS 170 may then transmit (step 1814) MSG2.

In FIG. 18, the UE 110 is illustrated as receiving (step 1816) MSG2 after a reflection at the first RIS 1800-1 and the second RIS 1800-2. As discussed hereinbefore, the BS 170 may include, in MSG2, an initial uplink grant. The initial uplink grant may, in this case, specify time slot 1.

In accordance with the initial uplink grant, the UE 110 transmits (step 1818) MSG3, a connection request in time slot 1.

In the second MBM mode, the second RIS 1800-2 is expected to redirect an incident wave carrying MSG3, transmitted (step 1818) by the UE 110 in time slot 1, toward the first RIS 1800-1. While redirecting the incident wave, the second RIS 1800-2 is expected to implement the instructions received in step 1812. That is, the second RIS 1800-2 is expected to modulate, according to the second MBM mode, one or more of a phase, a frequency, an amplitude or a polarization of an incident signal carrying MSG3.

In the first MBM mode, the first RIS 1800-1 is expected to redirect an incident wave carrying MSG3, transmitted (step 1818) by the UE 110 and redirected by the second RIS 1800-2, toward the BS 170. While redirecting the incident wave, the first RIS 1800-1 is expected to implement the instructions received in step 1712. That is, the first RIS 1800-1 is expected to modulate, according to the first MBM mode, one or more of a phase, a frequency, an amplitude or a polarization of the incident signal carrying MSG3.

The BS 170 receives (step 1820) MSG3 that was transmitted (step 1818) by the UE 110, reflected and modulated at the second RIS 1800-2 and reflected and modulated at the first RIS 1800-1.

Based upon the modulations, the BS 170, or another network entity, may determine whether communication with the UE 110 is to be carried out with or without help from one or more RIS.

As a matter of course, the BS 170 transmits (step 1822) MSG4 to the UE 110. As adapted according to aspects of the present application, MSG4 may include information indicating whether communication with the UE 110 is to be carried out with or without help from one or more RIS. MSG4 is a contention resolution message. MSG4 may also include RRC connection setup information. In the scenario presented in FIG. 18, MSG4 is expected to include information indicating that communication with the UE 110 is to be carried out with help from the first RIS 1800-1 and the second RIS 1800-2. As illustrated in FIG. 18, MSG4 arrives at the UE 110 after a reflection at the first RIS 1800-1 and a reflection at the second RIS 1800-2. The UE 110 receives (step 1824) MSG4 and processes the information indicating that communication with the UE 110 is to be carried out with help from the first RIS 1800-1 and the second RIS 1800-2. Notably, it is optional to transmit a message indicating that communication with the UE 110 is to be carried out with help from the first RIS 1800-1 and the second RIS 1800-2.

It should be clear that the approach described hereinbefore may be extended to more than two RIS or smart repeaters or a combination of RIS and smart repeaters. It is contemplated that it may be complicated to superpose multiple MBM modes in such a way that the modulation may be accurately decoded at the BS 170. In view of such complexity, a multiple time slot transmission approach may be used.

Two time slots may be defined, in contrast to the single time slot defined for the scenario described in view of FIG. 18.

The instructions, transmitted (step 1810) by the BS 170 to the first RIS 1800-1, may specify that a first MBM mode is to be implemented in a first time slot and that a regular redirection mode (i.e., a no modulation mode) is to be implemented in a second time slot.

The instructions, transmitted (step 1810) by the BS 170 to the second RIS 1800-2, may specify that a second MBM mode is to be implemented in the second time slot and that a regular redirection mode (i.e., a no modulation mode) is to be implemented in the first time slot. Notably, it is expected that the regular redirection mode takes into consideration a path for the SSB.

It follows that, when the BS 170 transmits (step 1814) MSG2, the BS 170 may include, in MSG2, two uplink grants; a first uplink grant specifies the first time slot and a second uplink grant specifies the second time slot. The UE 110 may transmit (step 1818) MSG3 in the first time slot and may transmit (step 1818) MSG3 in the second time slot.

The BS 170, upon receiving (step 1820) MSG3 twice, may perform an analysis to determine one of three scenarios. In a first scenario, the BS 170 communicates directly with the UE 110, that is, without use of a RIS. In a second scenario, via the BS 170 communicates with the UE 110 via the first RIS 1800-1. In a third scenario, via the BS 170 communicates with the UE 110 via the first RIS 1800-1 and the second RIS 1800-2.

In the arrangements presented hereinbefore, the MBM mode is active at a RIS in a manner that acts upon MSG3. It should be clear that, in alternative arrangements, a RIS may be configured so that an MBM mode is active at the RIS in a manner that acts upon other messages, such as MSG1. Indeed, a network element may configure a given RIS to redirect with MBM during RACH occasions of SSBs that are propagated through the given RIS.

Returning to the network illustrated in FIG. 6, aspects of the present application involve utilizing information, held at a network entity, specifying a location for the BS 170 and respective locations for the first RIS 604-1 and the second RIS 604-2, in conjunction with timing advance measurements to help determine an estimate for a propagation distance for a signal between the BS 170 and a given UE 110. Once the estimate of the propagation distance has been determined, the estimate may be used when determining whether the given UE 110 needs help from one or more RIS 604.

For example, consider a RACH procedure for the second UE 110-2 in FIG. 6. The RACH procedure illustrated in FIG. 9, wherein the UE 110 communicates with the BS 170 without the help of the RIS 900, and the RACH procedure illustrated in FIG. 10, wherein the UE 110 communicates with the BS 170 with the help of the RIS 1000, may serve as useful examples when considering RACH procedure for the second UE 110-2 in FIG. 6.

As is routine, the BS 170 may transmit (step 902, 1002) an SSB. As illustrated in FIG. 9, the SSB arrives at the UE 110 directly from the BS 170. As illustrated in FIG. 10, the SSB arrives at the UE 110 after a reflection at the RIS 1000. Upon receipt (step 904, 1004) of the SSB, the UE 110 may transmit (step 906, 1006) MSG1, a random access request. As illustrated in FIG. 9, MSG1 arrives at the BS 170 directly. As illustrated in FIG. 10, MSG1 arrives at the BS 170 after a reflection at the RIS 1000.

The BS 170 receives (step 908, 1008) MSG1. Timing advance measurements may be carried out at the BS 170 based on measurements obtained while receiving (step 908, 1008) MSG1. Based upon the timing advance measurements, the BS 170 may determine an estimate for a propagation distance for a signal between the BS 170 and the second UE 110-2.

Upon determining the estimate for the propagation distance, the BS 170 may determine that the estimate for the propagation distance does not exceed a known distance between the BS 170 and the second RIS 604-2. Accordingly, the BS 170 may note that the second UE 110-2 is unlikely to benefit from help from the second RIS 604-2 for communicating with the BS 170.

However, there may remain some ambiguity regarding whether the second UE 110-2 is likely to benefit from help from the first RIS 604-1 for communicating with the BS 170. This ambiguity may remain, for example, in a scenario in which a distance between the first RIS 604-1 and the BS 170 is less than the accuracy available for determining the estimate for the propagation distance on the basis of the timing advance measurements.

Accuracy for the estimate for the propagation distance is known to be a function of the bandwidth of the signal from which measurements are obtained as a basis for the determining the estimate. Indeed, it may be shown that timing advance measurements of a signal with a relatively wide bandwidth will lead to a more accurate estimate than the estimate available based on timing advance measurements of a signal with a relatively narrow bandwidth.

A routine part of the RACH procedure is transmission (step 914, 1014), by the BS 170, of MSG2. According to aspects of the present application, the BS 170 may include, in MSG2, a request that the second UE 110-2 transmit (step 918, 1018) MSG3 on a signal with a bandwidth that is wider than the signal on which MSG1 was transmitted.

Timing advance measurements may be carried out at the BS 170 based on measurements obtained while receiving (step 920, 1020) MSG3 carried on a signal with a wider bandwidth. Based upon the timing advance measurements, the BS 170 may determine a new estimate for a propagation distance for a signal between the BS 170 and the second UE 110-2. Based on the new estimate for the propagation distance, the BS 170 may determine that the second UE 110-2 communicates with the BS 170 via the first RIS 604-1.

As a matter of course, the BS 170 transmits (step 922, 1022) MSG4 to the second UE 110-2. As adapted according to aspects of the present application, MSG4 may include information indicating whether communication with the second UE 110-2 is to be carried out with or without help from one or more RIS. MSG4 is a contention resolution message. MSG4 may also include RRC connection setup information. In the scenario under discussion, MSG4 is expected to include information indicating that communication with the second UE 110-2 is to be carried out with help from the first RIS 604-1. As illustrated in FIG. 10, MSG4 arrives at the second UE 110-2 after a reflection at the first RIS 604-1. The second UE 110-2 receives (step 1024) MSG4 and processes the information indicating that communication with the second UE 110-2 is to be carried out with help from the first RIS 604-1. Notably, it is optional to transmit a message indicating that communication with the second UE 110-2 is to be carried out with help from the first RIS 604-1.

Aspects of the present application, as presented hereinbefore, relate to the BS 170, or other network element, determining, within the RACH procedure, whether communication with a given UE 110 is to be carried out with or without help from one or more RIS.

Further aspects of the present application relate to triggering the BS 170, or other network element, prior to the RACH procedure, to commence determining whether communication with a given UE 110 is to be carried out with or without help from one or more RIS.

As discussed hereinbefore, an SSB transmitted as part of an SSB burst may include a subsequent payload, which the UE can access through subsequent related transmissions. The payload may include a SIB1 or other SIB. Aspects of the present application relate to implementing, before the RACH procedure, a slight update to the payload (e.g., a few bits) in SIB1 or other SIB. The extra payload may be arranged to trigger some functions at the given UE 110. As a consequence of the functions triggered at the given UE 110, further functions may be triggered at the RIS, at the BS 170 or at another network element. Implementation of any of these functions may be seen as an update the RACH procedure. Furthermore, the implementation of any of these functions may be seen help the determining whether communication with the given UE 110 is to be carried out with or without help from one or more RIS.

In one example, a single new bit may be added to SIB1 during the IA process.

Responsive to determining that the new bit has a value of 0, the given UE 110 may transmit MSG1, or MsgA, once on a single RACH occasion via a selected beam. It may be understood that the new bit with a value of 0 may be included in the SIB1 carried in an SSB that is not redirected by a RIS.

Responsive to determining that the new bit has a value of 1, the given UE 110 may transmit MSG1 twice over two RACH occasions via the selected beam. Aspects of a relationship between the two RACH occasions, e.g., a time difference between a first RACH occasion and a second RACH occasion, may be standardized or communicated through another new part of a SIB. It may be understood that the new bit with a value of 1 may be included in the SIB1 carried in an SSB that is redirected by a RIS.

During one of the two RACH occasions, the RIS may be configured, by the BS 170 or another network element, for proper redirection, in consideration of the propagation path of the selected SSB. During the other of the two RACH occasions, the RIS may be configured, by the BS 170 or another network element, for improper redirection or to work in absorption mode.

The BS 170 or the other network element may be configured to track MSG1 over two RACH occasions.

Upon determining that MSG1 has been received over two RACH occasions, the BS 170, or other network element, may determine that communication with the given UE 110 is to be carried out without help from the RIS.

Upon determining that MSG1 has been received over only one of the RACH occasions, the BS 170, or other network element, may determine that communication with the given UE 110 is to be carried out with help from the RIS.

Notably, for a scenario in which the MSG1 is to be transmitted over more than two RACH occasions, more than one bit may be employed.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
transmitting, to a Reconfigurable Intelligent Surface (RIS), instructions specifying:
a first mode for implementing in a first resource; and
a second mode for implementing in a second resource;
transmitting, to a device, outbound messages, the outbound messages including:
in the first resource, a first outbound message; and
in the second resource, a second outbound message; and
receiving an inbound message, the inbound message including an indication indicating that one or more of the first outbound message and the second outbound message has been received at the device; and
determining, based on the device having received one or more of the first outbound message or the second outbound message, whether communication with the device occurs via the RIS.

2. The method of claim 1, further comprising:
transmitting a third outbound message, the third outbound message including an indication indicating that communication with the device occurs via the RIS.

3. The method of claim 1, further comprising:
before transmitting the first outbound message, receiving, from the device, a first random access preamble.

4. The method of claim 3, wherein the first outbound message comprises a first random access response to the first random access preamble.

5. The method of claim 3, wherein the first outbound message comprises an indication indicating that there is a second outbound message at specific resource allocation.

6. An apparatus comprising:
a memory storing instructions; and
at least one processor caused, by executing the instructions, to:
transmit, to a Reconfigurable Intelligent Surface (RIS), instructions specifying:
a first mode for implementing in a first resource; and
a second mode for implementing in a second resource;
transmit, to a device, outbound messages, the outbound messages including:
in the first resource, a first outbound message; and
in the second resource, a second outbound message; and
receive an inbound message, the inbound message including an indication indicating that one or more of the first outbound message and the second outbound message has been received at the device; and
determine, based on the device having received one or more of the first outbound message and the second outbound message, whether communication with the device occurs via the RIS.

7. The apparatus of claim 6, wherein the at least one processor is further caused to:
transmit a third outbound message, the third outbound message including an indication indicating that communication with the device occurs via the RIS.

8. The apparatus of claim 6, wherein the at least one processor is further caused to:
before transmitting the first outbound message, receive, from the device, a first random access preamble.

9. The apparatus of claim 8, wherein the first outbound message comprises a first random access response to the first random access preamble.

10. The apparatus of claim 8, wherein the first outbound message comprises an indication indicating that there is a second outbound message at specific resource allocation.

11. A method comprising:
receiving, from a network element, one or more inbound messages;
transmitting, to the network element, an outbound message, the outbound message including an indication indicating that the one or more inbound messages have been received; and
receiving, from the network element, a further inbound message, the further inbound message including an indication indicating that communication with the network element occurs via a Reconfigurable Intelligent Surface.

12. The method of claim 11, further comprising:
before receiving the first inbound message, transmitting, to the network element, a first random access preamble.

13. The method of claim 12, wherein the first inbound message comprises a first random access response to the first random access preamble and an indication indicating that there is a second inbound message at specific resource allocation.

14. The method of claim 13, wherein the second inbound message comprises a first random access response.

15. An apparatus comprising:
a memory storing instructions; and
at least one processor caused, by executing the instructions, to:
receive, from a network element, one or more inbound messages;
transmit, to the network element, an outbound message, the outbound message including an indication indicating that the one or more inbound messages have been received; and
receive, from the network element, a further inbound message, the further inbound message including an indication indicating that communication with the network element occurs via a Reconfigurable Intelligent Surface.

16. The apparatus of claim 15, wherein the at least one processor is further caused to:
before receiving the first inbound message, transmit, to the network element, a first random access preamble.

17. The apparatus of claim 16, wherein the first inbound message comprises a first random access response to the first random access preamble and an indication indicating that there is a second inbound message at specific resource allocation.

18. The apparatus of claim 17, wherein the second inbound message comprises a first random access response.
